(19) United States
(12) Patent Application Publication
(10) Pub. No.: US 2010/0048272 A1
(43) Pub. Date: Feb. 25, 2010

(54) MEASURING AND CONVERTING ACTIVITIES TO BENEFITS

(75) Inventor: Bobby Koh, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: SONY ONLINE ENTERTAINMENT LLC, San Diego, CA (US)

(21) Appl. No.: 12/333,722

(22) Filed: Dec. 12, 2008

Related U.S. Application Data
(60) Provisional application No. 61/090,849, filed on Aug. 21, 2008.

(51) Int. Cl. A63F 9/24; A63F 13/00

(52) U.S. Cl. 463/7; 463/48; 463/36

(57) ABSTRACT

Measuring and converting physical activities to benefits, including: measuring a physical activity of a user using a measuring device; converting the measurement made by the measuring device to service benefits using predetermined formulas, wherein the service benefits are consistent and balanced to time needed to attain a similar reward from engaging only in a target activity; and providing the benefits.

### CROSS-REFERENCE TO RELATED APPLICATIONS

This application claims the benefit of priority of co-pending U.S. Provisional Patent Application No. 61/090,849, filed Aug. 21, 2008, entitled “Sweat XP”. The disclosure of the above-referenced patent application is incorporated herein by reference.

### BACKGROUND

1. Field of the Invention

The present invention relates to activities, and more specifically, to measuring and converting activities to online and/or offline benefits.

2. Background

A problem confronted by many game players, and often others around the game players, is the dilemma between spending time playing a game and spending time exercising. An example of playing a game includes further progressing a character in a massively multiplayer online role-playing game (MMORPG). Examples of exercising include running and using exercise machines. One solution has been to combine exercising and playing a game at the same time by making game controllers be more physically interactive and games involving more physical movements.

### SUMMARY

The present invention provide a technique for measuring and converting physical activity of a user to benefits and using that information in a computer environment, such as a computer game.

In one implementation, a method of measuring and converting physical activities to benefits is disclosed. The method includes: measuring a physical activity of a user using a measuring device; converting the measurement made by the measuring device to service benefits using predetermined formulas, wherein the service benefits are consistent and balanced to time needed to attain a similar reward from engaging only in a target activity; and providing the benefits.

In another implementation, a system of measuring and converting physical activities to benefits is disclosed. The system includes: a measuring device configured to measure a physical activity of a user; a conversion module configured to convert the measurement made by the measuring device to service benefits using predetermined formulas, wherein the service benefits are consistent and balanced to time needed to attain a similar reward from engaging only in a target activity; and a benefits manager configured to provide the benefits.

In a further implementation, a computer-readable storage medium storing a computer program for measuring and converting physical activities to benefits is disclosed. The computer program comprises executable instructions that cause a computer to: measure a physical activity of a user; convert the measurement to service benefits using predetermined formulas, wherein the service benefits are consistent and balanced to time needed to attain a similar reward from engaging only in a target activity; and provide the benefits.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating an activity measurement and conversion process in accordance with one implementation of the present invention.

FIG. 2 is a flowchart illustrating a process of converting the measure of physical activity to benefits in accordance with one implementation of the present invention.

FIG. 3 is a flowchart illustrating a process of various ways in which the benefits can be accessed in accordance with one implementation of the present invention.

FIG. 4 is a block diagram of a system for converting the measure of physical activity to benefits in accordance with one implementation of the present invention.

FIG. 5A illustrates a representation of a computer system and a user.

FIG. 5B is a functional block diagram illustrating the computer system hosting the activity monitor.

### DETAILED DESCRIPTION

Certain implementations as disclosed herein provide for systems, apparatus and methods to implement a technique for measuring and converting physical activity of a user to benefits and using that information in a computer environment, such as a computer game. Features provided in implementations can include, but are not limited to: storing data reflecting measured physical activity; converting stored activity data into benefit points; managing user accounts of benefit points; and providing access to service benefits for the user in exchange for benefit points. Examples of service benefits include: experience points (XP); temporary game bonuses; in-game clothing or artwork; demos of games; video sequences, programs or movies; and other benefits or boosts for the user. Thus, examples of target activities for the service benefits include: online games; offline activities such as attending movies and contests; and other online activities such as viewing media content.

After reading this description it will become apparent how to implement the invention in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present invention.

In one implementation, a computer system records measured physical activity of a user and converts the activity to points. The points are stored in the user's account. The user can then spend the accumulated points in the user's account for services provided by the computer system or an affiliated system, such as access to new content or in-game benefits.

In one example implementation, a user obtains and records exercise data using a personal device or a machine. The exercise data is obtained while running, exercising at a gym, or otherwise engaging in real-world physical activities. A measure of that physical activity is then converted to benefit points or work units based upon predetermined formulas which can then be spent on various in-game benefits such as benefits or boosts to the user's characters.

In another implementation, a game application of the technique would allow users to exercise and by keeping track of how much they exercised, a system implementing the technique can convert that into a “currency” that can be spent on items or buffs for progressing users' characters. This can address the dilemma of choosing between exercising and making the in-game character better by allowing users to do both.

In an alternative implementation, the system that records the user's activity, the system that manages the user's account of work units, and the system that provides the game benefits are all operated by different service providers. Thus, the user may need an account with each affiliate.

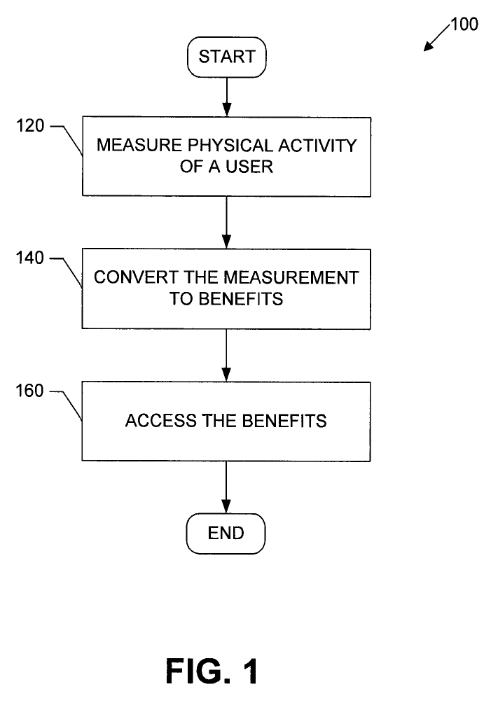

FIG. 1 is a flowchart illustrating an activity measurement and conversion process 100 in accordance with one implementation of the present invention. Although the activity measurement and conversion process, in the illustrated implementation, is described as a technique for measuring and converting physical activity of a user and using that information in a computer environment, such as a computer game, this technique can be modified so that the information can be used in environment other than a computer environment. For example, the information can be used to provide awards or bonuses of money or prizes.

In the illustrated implementation of FIG. 1, the activity measurement and conversion process 100 includes initially measuring physical activity of a user, at box 120. As described above, measurable physical activities include running, exercising at a gym, or otherwise engaging in real-world physical activities, such as working or driving. The physical activity can be measured using a personal device or a machine. For example, a personal device can be attached or otherwise coupled to the user's body to measure the movement of arms or legs, or to measure the heart rate. In another example, the physical activity can be measured directly from the exercise machine to obtain the amount of physical exercise performed by a user.

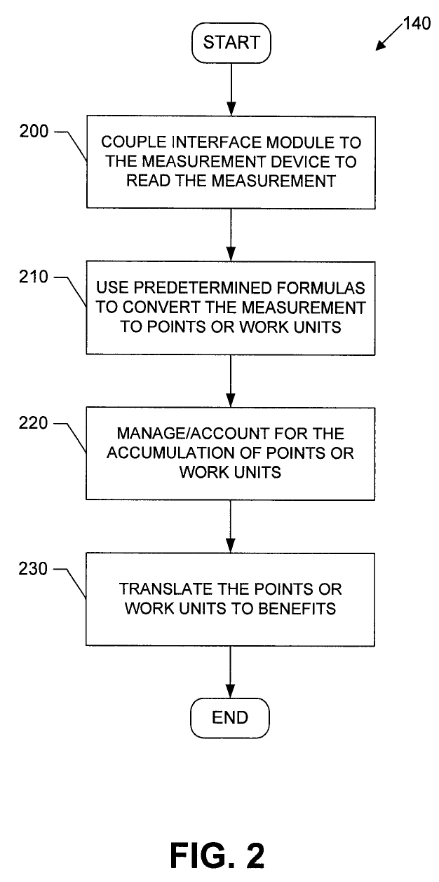

The physical activity measurement is then converted to benefits, at box 140. In one implementation, the conversion process 140 is described in detail in FIG. 2.

FIG. 2 is a flowchart illustrating a process 140 of converting the measure of physical activity to benefits in accordance with one implementation of the present invention. In the illustrated implementation of FIG. 2, the conversion process 140 includes coupling an interface module to a device that measures the physical activities to read the measurement, at box 200. In one example, the interface module is an optical module coupled to the wheel of an exercise bicycle to read the number of rotations. In another example, the interface module is a cable that connects a digital heart rate monitoring device to a computer to read the measurement made by the monitoring device.

Predetermined formulas are used, at box 210, to convert the measurement to points or work units that can be tracked. For example, the points or work units can be a numerical value corresponding to the number of minutes spent in performing the physical activities multiplied by an intensity factor, which is also measured by the measuring device. In one example, the intensity factor can be an average heart rate during the physical activities. By using standard benchmarks of calories burned or average heart rate, formulas can be derived for how much reward should be attainable with a certain amount of effort. The points or work units converted using the formulas should stay consistent and balanced to the time needed to attain a similar reward from just playing the game.

The accumulated points or work units are accounted for and managed by a manager unit, at box 220, and are then translated into benefits, at box 230. Benefits can be either offline benefits, online benefits, or a combination of both.

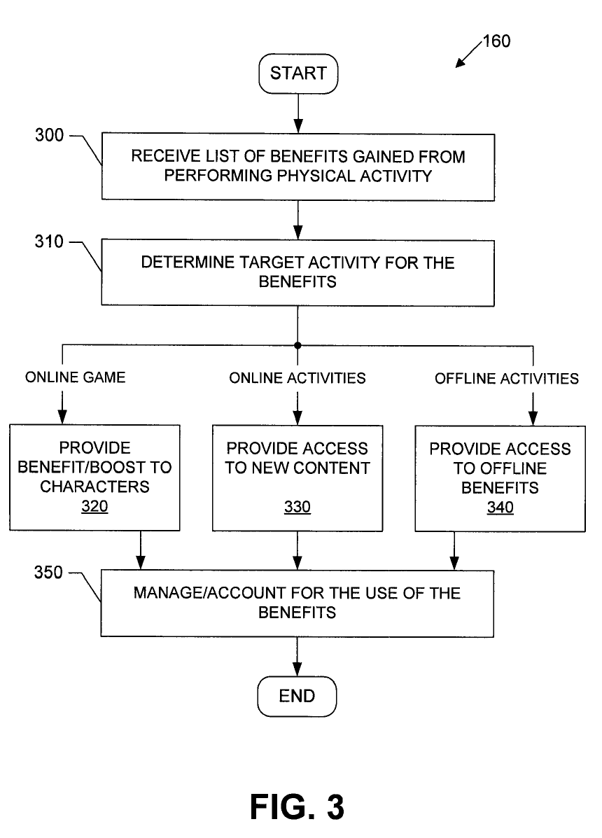

Referring back to FIG. 1, the activity measurement and conversion process 100 further includes accessing the benefits, at box 160. In one implementation, the benefits access process 160 is described in detail in FIG. 3.

FIG. 3 is a flowchart illustrating a process 160 of various ways in which the benefits can be accessed or provided in accordance with one implementation of the present invention. In the illustrated implementation of FIG. 3, the benefits access process 160 includes receiving, at box 300, a list of benefits gained from performing the physical activities. In one implementation, the user selects at least one specific benefit from the list of benefits depending on a target activity for the benefits.

For example, at box 310, a target activity for the benefits is determined. Then, if the target activity is an online game, benefits or boosts to the game characters can be provided, at box 320. In this example, the user is allowed to purchase in-game items or benefits, as selected. Examples of in-game items or benefits include: damage buffs; party and/or raid buffs; consumables (e.g., XP potions, damage potions) or gathered resources; extra XP bonuses or rate of gain increase, such as rested XP; crafting and trade-skilling (e.g., x units of exercise points=1 skill-up; x units to exercise points required to make [Shoes of the Running Man]); increasing player attributes (e.g., +stamina, strength); minor benefits only available from using the program. Items or buffs attained by this method should be distinguished as uniquely belonging to the program. Items “purchased” should immediately be available in-game for the character specified by the user.

If the target activity is an online activity, access to new content can be provided, at box 330. Otherwise, if the target activity is an offline activity, access to offline benefits, such as a ticket to a theater, can be provided, at box 340. At box 350, the use of the benefits are accounted for and managed.

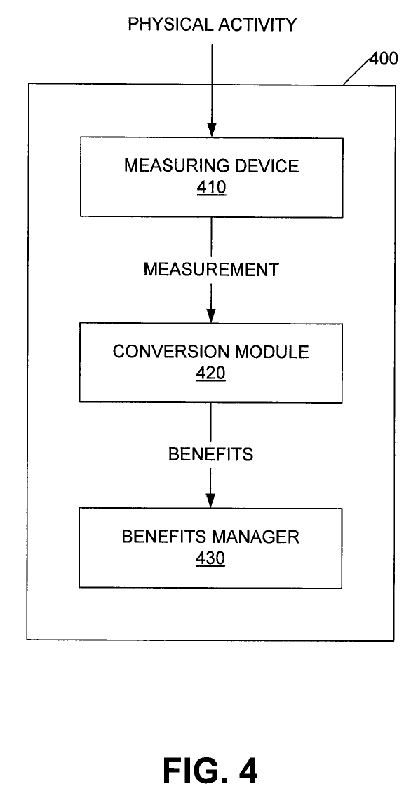

FIG. 4 is a block diagram of a system 400 for converting the measure of physical activity to benefits in accordance with one implementation of the present invention. In the illustrated implementation, the system 400 includes a measuring device or machine 410, a conversion module 420, and a benefits manager 430.

The measuring device or machine 410 measures the exercise data while running, exercising at a gym, or otherwise engaging in real-world physical activities. For example, as described above, a measuring device can be attached or otherwise coupled to the user's body to measure the movement of arms or legs, or to measure the heart rate. In another example, the physical activity can be measured directly from the exercise machine to measure the amount of physical exercise performed by the user. Thus, in this case, the measuring device or machine 410 can include the exercise machine and any other additional devices attached to the machine to measure the exercise data.

The conversion module 420 converts the measure of physical activity to benefits, which can be used to obtain various offline and/or online benefits. In one implementation, the conversion module 420 includes an interface module that couples to the measuring device 410 for reading the exercise data from the measuring device 410. As discussed above, in one example, the interface module is an optical module coupled to the wheel of an exercise bicycle to read the number of rotations. In another example, the interface module is a cable that connects a digital heart rate monitoring device to a computer to read the measurement made by the monitoring device.

The conversion module 420 can also include a converter that converts the measurement of exercise data to points or work units using predetermined formulas. For example, the points or work units can be a numerical value corresponding to the number of minutes spent in performing the physical activities multiplied by an intensity factor, which is also measured by the measuring device.

The conversion module 420 can further include: a manager unit to account for and manage the accumulated points or work units; and a translator to translate the accumulated points or work units into benefits. Benefits can be either offline benefits, online benefits, or a combination of both.

The benefits manager 430 accesses and manages the benefits obtained as a result of physical activities performed by a user. In one implementation, the benefits manager 430 includes a receiver for receiving a list of benefits gained from performing the physical activities. In one implementation, the user selects at least one specific benefit from the list of benefits depending on a target activity for the benefits.

For example, if the target activity for the benefits is an online game, the benefits manager 430 can negotiate with the online game provider to provide benefits or boosts to characters in the game. If the target activity is an online activity, the benefits manager 430 can negotiate with an online content provider to provide access to new content. Otherwise, if the target activity is an offline activity, the benefits manager 430 can negotiate with an offline benefits provider to provide access to offline benefits, such as a ticket to a theater.

In some implementations, a system, such as the system 400 for converting the measure of physical activity to benefits, can be configured to start with the incorporation of national gyms as well as personal devices with established communities as input devices. Since each user is different and exercises in different ways and at his/her own pace, the system can have several different options available. Thus, existing physical activity devices with an established upload and/or data capture infrastructure can be advantageous for ease of implementation. Further, devices that are harder to simulate, and thus, difficult to generate false or counterfeit exercise data would be preferred to curtail abuse.

In the context of a game system, the game service provider should accommodate the physical activity measuring and converting system (e.g., the system 400) by providing a reliable technique to convert the exercise data into benefits or reward units. In this case, the game system, which includes the physical activity measuring and converting system, should have different conversion rates based on the type of fitness data, and diminishing returns to discourage extreme abuse. Further, the game system can allow the user to monitor the amount of reward units remaining and can have a “store” where in-game items and benefits can be “purchased”.

Examples of aspects of other implementations include: parental control system where play time is allocated based on amount of exercise points; other allowance systems where play time is determined by workout time/effort; “goals” (or Quests) that can be completed with exercise points; variations of “currency” other than exercise points, such as “commuter” points (e.g., people might feel better that the time they spend in traffic is going towards something) or “promotional” points for going to a service provider or affiliated event (e.g., conventions, movie openings, and other applicable events); use of exercise data for competitions between guilds, servers, regions in-game; incorporating this system into a combination gymnasium and gaming cafe; and using measured physical activity from one game or activity to generate points and/or benefits in another game, computer application, or online service.

Examples of further implementations include affiliating online and/or offline benefits to activities associated with charities. For example, a maker of activity measuring device can be partnered with a charity organization so that participants in a charity event can be given credit ‘points’ or in-game buffs. In another example, a player/participant can receive a sponsorship and the buff would be the sponsor's icon. This would benefit the player/participant as well as the charity organization which may receive donation from the sponsor.

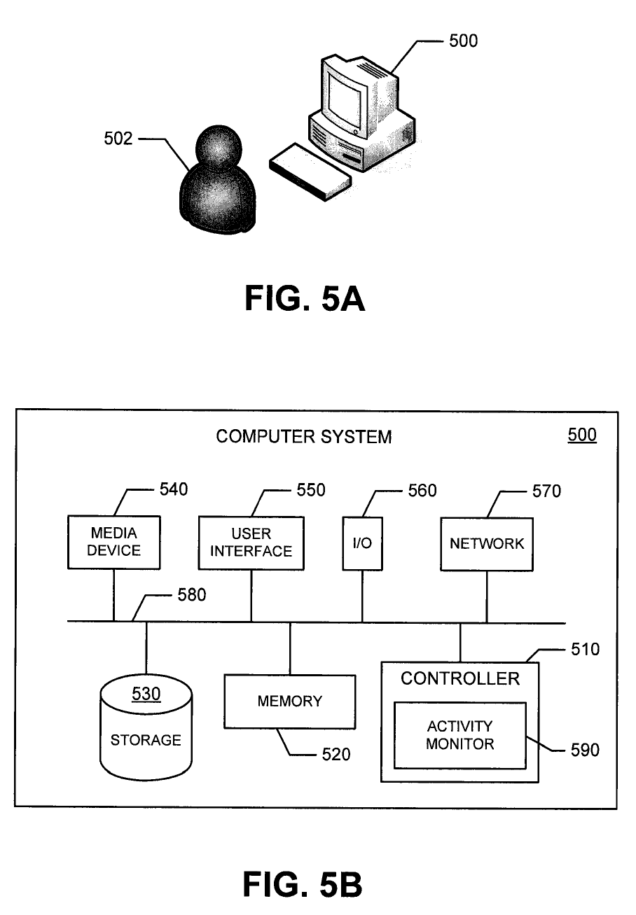

FIG. 5A illustrates a representation of a computer system 500 and a user 502. The user 502 uses the computer system 500 to measure and convert physical activity of a user to benefits. The computer system 500 stores and executes activity monitor 590.

FIG. 5B is a functional block diagram illustrating the computer system 500 hosting the activity monitor 590. The controller 510 is a programmable processor and controls the operation of the computer system 500 and its components. The controller 510 loads instructions (e.g., in the form of a computer program) from the memory 520 or an embedded controller memory (not shown) and executes these instructions to control the system. In its execution, the controller 510 provides the activity monitor 590 as a software system. Alternatively, this service can be implemented as separate hardware components in the controller 510 or the computer system 500. The controller 510 controls data in the purchase and access of the benefits.

Memory 520 stores data temporarily for use by the other components of the computer system 500. In one implementation, memory 520 is implemented as RAM. In one implementation, memory 520 also includes long-term or permanent memory, such as flash memory and/or ROM.

Storage 530 stores data temporarily or long term for use by other components of the computer system 500, such as for storing measurement data, storage of rewards or benefit data. In one implementation, storage 530 is a hard disk drive.

The media device 540 receives removable media and reads and/or writes data to the inserted media. In one implementation, for example, the media device 540 is an optical disc drive.

The user interface 550 includes components for accepting user input from the user of the computer system 500 and presenting information to the user 502. In one implementation, the user interface 550 includes a keyboard, a mouse, audio speakers, and a display. The controller 510 uses input from the user to adjust the operation of the computer system 500.

The I/O interface 560 includes one or more I/O ports to connect to corresponding I/O devices, such as external storage or supplemental devices (e.g., a printer or a PDA). In one implementation, the ports of the I/O interface 560 include ports such as: USB ports, PCMCIA ports, serial ports, and/or parallel ports. In another implementation, the I/O interface 560 includes a wireless interface for communication with external devices wirelessly.

The network interface 570 includes a wired and/or wireless network connection, such as an RJ-45 or “Wi-Fi” interface (including, but not limited to 802.11) supporting an Ethernet connection.

A system communication path 580 (e.g., a system communication bus) provides for transfers of data and control information between the media device 540, user interface 550, I/O interface 560, network interface 570, storage 530, memory 520, and controller 510.

The computer system 500 includes additional hardware and software typical of computer systems (e.g., power, cooling, operating system), though these components are not specifically shown in FIG. 5B for simplicity. In other implementations, different configurations of the computer system can be used (e.g., different bus or storage configurations or a multi-processor configuration).

The systems and apparatus for measurement, account management, transactions, and benefits, can be integrated into one system or provided as combinations of multiple systems, and can be operated by the same company, related or affiliated entities, third parties, or a combination.

Various implementations are or can be implemented primarily in hardware using, for example, components such as application specific integrated circuits (“ASICs”), or field programmable gate arrays (“FPGAs”). Implementations of a hardware state machine capable of performing the functions described herein will also be apparent to those skilled in the relevant art. Various implementations may also be implemented using a combination of both hardware and software.

Furthermore, those of skill in the art will appreciate that the various illustrative logical blocks, modules, connectors, data paths, circuits, and method steps described in connection with the above described figures and the implementations disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Various illustrative implementations of the present invention have been described. However, one of ordinary skill in the art will see that additional implementations are also possible and within the scope of the present invention. For example, the above discussion focuses on measuring physical activity. However, other types of measurable activity could be used as a basis for accessing benefits.

In one example, the amount of time spent studying is measured and translated into a game benefit, such as a number of minutes which a player is allowed to play (e.g., input to a parental control feature). In another example, successful achievements in academics (e.g., test scores from a software tool or from an online source, such as a school database) are translated into benefits, such as successful foreign language progress by a student translates into a game character learning that foreign language. In yet another example, consumption of media translates into benefits, such as watching selected content for a defined amount of time provides access to new content. Accordingly, the present invention is not limited to only those implementations described above.

1. A method of measuring and converting physical activities to benefits, the method comprising:
measuring a physical activity of a user using a measuring device;
converting the measurement made by the measuring device to service benefits using predetermined formulas,
wherein the service benefits are consistent and balanced to time needed to attain a similar reward from engaging only in a target activity; and
providing the benefits.

2. The method of claim 1, further comprising
coupling an interface module to the measuring device to read the measurement from the measuring device.

3. The method of claim 2, wherein the interface module includes an optical module.

4. The method of claim 2, wherein the interface module includes a cable that connects it to the measuring device.

5. The method of claim 1, wherein the measurement is converted to points or work units that can be tracked.

6. The method of claim 5, further comprising
accounting for and managing the points or work units.

7. The method of claim 6, further comprising
translating the points or work units to the benefits.

8. The method of claim 7, wherein the provided benefits are online benefits for an online game to boost game characters.

9. The method of claim 1, further comprising
managing the benefits obtained as a result of the physical activity performed by the user.

10. The method of claim 1, further comprising
selecting at least one specific benefit from the benefits depending on the target activity.

11. The method of claim 10, further comprising
negotiating with an online game provider to provide boosts to in-game characters when the target activity is an online game.

12. A system of measuring and converting physical activities to benefits, the system comprising:
a measuring device configured to measure a physical activity of a user;
a conversion module configured to convert the measurement made by said measuring device to service benefits using predetermined formulas,
wherein the service benefits are consistent and balanced to time needed to attain a similar reward from engaging only in a target activity; and
a benefits manager configured to provide the benefits.

13. The system of claim 12, further comprising
an interface module coupled to said measuring device to read the measurement from said measuring device.

14. The system of claim 13, wherein said interface module includes an optical module.

15. The system of claim 13, wherein said interface module includes a cable that connects it to said measuring device.

16. The system of claim 12, wherein said conversion module converts the measurement to points or work units that can be tracked.

17. The system of claim 16, further comprising
a points manager configured to account for and manage the points or work units.

18. The system of claim 17, further comprising
a translator to translate the points or work units to the benefits.

19. The system of claim 12, further comprising
a selector to select at least one specific benefit from the benefits depending on the target activity.

20. The system of claim 19, wherein said benefits manager is configured to negotiate with an online game provider to provide boosts to in-game characters when the target activity is an online game.

21. A computer-readable storage medium storing a computer program for measuring and converting physical activities to benefits, the computer program comprising executable instructions that cause a computer to:
measure a physical activity of a user;
convert the measurement to service benefits using predetermined formulas,
wherein the service benefits are consistent and balanced to time needed to attain a similar reward from engaging only in a target activity; and
provide the benefits.
